(19) United States
(12) Patent Application Publication
(10) Pub. No.: US 2017/0161709 A1
(43) Pub. Date: Jun. 8, 2017

(54) METHOD AND SYSTEM TO ORGANIZE AND MANAGE TRANSACTIONS

(71) Applicant: NXT-ID, Inc., Shelton, CT (US)

(72) Inventors: Andrew Tunnell, Palm Bay, FL (US); David Tunnell, Melbourne, FL (US)

(21) Appl. No.: 15/368,546

(22) Filed: Dec. 2, 2016

Related U.S. Application Data
(60) Provisional application No. 62/262,138, filed on Dec. 2, 2015.

(51) Int. Cl. G06Q 20/20; G06Q 20/32; G06Q 20/40; G06Q 30/02

(52) U.S. Cl. CPC G06Q 20/206; G06Q 20/202; G06Q 30/0226; G06Q 20/327; G06Q 20/40145

(57) ABSTRACT

A system for managing a transaction. The system includes a content-storing component that conducts the transaction and a transaction-detecting component for determining when the content-storing component has performed or is performing the transaction. A recording component records the transaction.

### CROSS REFERENCE TO RELATED APPLICATIONS

This patent application claims the benefit of U.S. provisional patent application filed on Dec. 2, 2015 and assigned Application No. 62/262,138, which is incorporated herein in its entirety.

### FIELD OF THE INVENTION

The present invention relates to the general fields of accounting and payment processing, as well as personal inventory management and inter-device proximity detection.

### BACKGROUND OF THE INVENTION

Accounting is often a difficult task that most consumers and business professionals struggle to manage. Most of the time, this includes the meticulous process of writing down an array of numbers from receipts. Often, receipts are lost and applying the proper accounting code may be time consuming and confusing. This not only causes a headache for the consumer, but often an improperly accounted for transaction.

Attempts to solve this problem include prior art techniques such as described in U.S. Pat. No. 5,630,073, wherein a user is able to scan in a tangible medium such as a check or deposit slip through “machine readable means.” After the tangible medium has been read, it may be sent to a database where a user may easily access it. Although this method stores the transaction information, it still requires action on the part of either the user or the institution to “scan” or provide the information as presented on the tangible medium, as well as to manually assign an accounting code to the transaction.

Optical solutions have also been attempted to resolve this problem such as described in U.S. Pat. No. 8,861,861. Herein, an OCR or “optical character reader” identifies characters on a receipt. The user first takes a picture of the receipt. Two sets of “information items” are extracted from the input using an OCR. A non-transitory computer readable medium then searches through several of the user's financial resources, such as the user's accounts. After identifying such resources, the computer searches through several transactions in order to match the information received from the receipt to a correct transaction.

Similarly, US published patent application number 2012/0221,446 describes a method wherein the retailer sends a receipt to the consumer through various means including email and text message. The receipt may also be sent to the consumer's “e-receipt” account. After the receipt is received, it is categorized by matching it to a purchase transaction present in the consumer's bank account. This task may be executed either by a processing device or a computer program product.

EP 1,839,238 A1 describes a method wherein financial information is sent from a “master financial application program” on a computer to a “mobile financial application program” on a mobile device. The connection may be wireless or wired depending on the technique used. Once the financial information is received by the mobile device, it may be recorded in a given budget category. The user may then be able to accept or reject recording of the information.

### SUMMARY OF THE INVENTION

The present invention discloses a system and method to manage contents frequently found within personal storage accessories such as wallets, cards, wristlets, watches, bands, purses or even luggage, and record and/or categorize financial information from a transaction. Personal storage accessories typically store payment cards, identification cards, insurance cards and the like (sometimes referred to as a transactional device or a content-storing component herein).

These content-storing components are typically handed to another person, such as a merchant, to execute a payment or transfer information. Unfortunately, the user may forget to record the transaction or receipts may be lost, hindering the user's ability to manage money, information, and time.

The present invention manages all inventory of a personal storage accessory by automatically detecting when a specific content-storing component is moved or performs a transaction, and sending notifications related thereto to the user. That personal storage accessory may further comprise a wallet, purse, suitcase, closed or any container or space that stores or contains multiple items. If each item is individually and uniquely tagged, then the personal storage accessory can determine any item that has been removed or conversely any item that remains within the accessory. In a sense, the personal storage accessory operates as a supervisor (or inventory management device) over the items stored within the accessory or more generally, container. In an application where the personal storage accessory comprises a wallet storing transaction cards, the removal of a transaction card can be detected. The user can be notified that the card has been removed.

The invention further comprises elements that authenticate and interface with a user, securely store, manage and retrieve private information, and act as a payment instrument and/or a beacon and/or communication device. Any one of the beacons and/or transactions and/or communications are activated by some motion of the device, including walking, tapping or another motion

In some aspects of the invention, the transactional device may interface with other devices and/or services, such as an advertisement, or with store/location beacons that promote specific accounts and/or loyalty to a retail establishment.

In some embodiments, the personal storage accessory and/or the content-storing components serves as a personal vault that can securely store, manage and retrieve a user's private information. In some embodiments, the content-storing component acts as a payment instrument to execute transactions, such as but not limited to financial transactions, identification transactions, advertisement transactions, and the like, via electronics integrated within the personal storage accessory, or via electronics on the content-storing component when not stored within the accessory. When used herein, “electronics” refers to electronic devices and/or components operative to perform a function.

For embodiments when a content-storing component is removed from an accessory, a magnetic or another-type switch, such as but not limited to reed switch or a Hall effect switch, may be used to detect that a content-storing component stored within the accessory has been removed and/or the accessory has been opened. Hall effect switch/sensor may be preferable as it provides a better “sense” of a magnetic field and can better discriminate ambient fields created by electromagnetic field generating devices, such as but not limited to AC power lines, transformers, and the like.

According to this invention, electronics integrated within an accessory may be activated (turned on) by disturbing an associated magnetic field when the accessory is opened. Likewise, a removable electronics device, such as a thin laminated card, a content-storing component, or a package carrying electronics, stored within a pocket of the accessory, may be activated (turned on) by removal of the electronics device from a pocket of the accessory, or by any detected movement. This removal can be sensed, for example, by the separation of two sensors, one sensor on the electronics device and the other sensor on or within the pocket. For instance, an accelerometer, gyro or other motion sensor could be in one or both devices, and motion of one device relative to the other could be used to detect some transaction is taking place, and automatically start communications such as BLE (Bluetooth Low Energy) and/or beacons and/or enabling payment transactions over other communications including BLE, NFC (Near Field Communications), WiFi or the like.

Another aspect of the invention categorizes financial information related to the transaction. For a non-limiting example, an element of a transaction may comprise a single item purchased at a grocery store that can be categorized or coded as food purchase.

This categorization process may be accomplished based on specific financial information associated with the transaction, and is referenced herein as an “identifier.” Identifiers may include parameters that describe into which category or accounting code the transaction best fits.

According to another embodiment, as a content-storing component is removed from an accessory for the purpose of performing a particular function using, such as making a payment, the transaction may be determined based solely on the removal and/or the motion of the content-storing component relative to the accessory.

As various financial transactions, such as payments, wire transfers, rewards and the like are performed, identifiers may be utilized to categorize or classify the transaction by assignment of a predetermined accounting code to that transaction.

In yet another method, one entity to a transaction may utilize identifiers to categorize a transaction or an element of such and then indicate the appropriate category in the form of a code. In some embodiments, the user may be able to accept, reject, or change a suggested category for a transaction, while in other embodiments, a user may be able to manually enter financial information and select and/or enter a category and/or code.

According to one embodiment, a transaction device, or device connected to a transaction device, may also track and/or display spending and/or rewards as purchases occur. Spending and/or rewards may be tracked per account, card, accounting code, and/or another category, as well as balances, budgets, etc. on a per account or per transaction or per device basis.

In other embodiments, a specific category for the transaction may be determined along with detecting the physical presence or removal of a transaction card. For example, if a transaction device can be used to conduct a transaction only as related to a certain category, or account, then it can be determined that detection of a specific motion of a transaction device preceded the execution of a transaction related to that category or account. Such a detection system not only bolsters a user's ability to track which category and/or account was used for the transaction, but may also prevent loss and/or fraud of the transaction by one “accessory device” monitoring another “transaction device”.

Authentication techniques that determine that the user is who he or she says he or she is, such as but not limited to biometrics, behavior metrics, PINs, and/or passwords, further increase fraud prevention, as well as determines the identity of the person at the time of a transaction. Certain authentication techniques may additionally indicate details related to the transaction to be executed. As a non-limiting example, a specific authentication technique may authenticate the user and also indicate that the specific transaction is a payment against an identified account and/or user. In some embodiments, the transaction device and/or the accessory device may communicate with a point-of-sale system (PoS) to perform financial, reward, identification, and/or other transactions. In yet other embodiments, a financial transaction may take place with one entity, such as a PoS system, while also communicate with another separate entity to receive or send rewards or other information. In some instances, the accounting information to be coded may be sent to the transaction device and/or the accessory device from either of these or other entities.

Such a system represents a “pocket accountant” system, whereby users may automatically or manually categorize financial transactions as they perform them. In some embodiments, the financial transactions may be automatically sent to an accounting system, where all expenditures are categorized per their associated category or accounting code. This automatic feature should facilitate rapid and accurate accounting processes.

### BRIEF DESCRIPTION OF THE DRAWINGS

The skilled artisan will understand that the drawings, described below, are for illustration purposes only. The drawings are not intended to limit the scope of the present invention in any way.

FIG. 1 illustrates steps in execution of a financial transaction.

FIG. 2 illustrates a transaction summary.

FIG. 3 illustrates an exemplary behavior metric.

FIGS. 4 and 5 illustrate an electronic inventory system stored within a wallet.

FIG. 6 illustrates devices associated with a proximity detection feature.

FIG. 7 illustrates devices associated with beacon or tethering signals.

FIG. 8 illustrates exemplary electronics devices disposed within an accessory.

FIG. 9 illustrates batteries stored within a wallet.

### DETAILED DESCRIPTION OF THE PREFERRED EMBODIMENTS

Before describing in detail the particular methods and apparatuses related to detecting, categorizing, organizing and managing financial transactions, it should be observed that the embodiments of the present invention reside primarily in a novel and non-obvious combination of elements and method steps. So as not to obscure the disclosure with details that will be readily apparent to those skilled in the art, certain conventional elements and steps have been presented with lesser detail, while the drawings and the specification describe in greater detail other elements and steps pertinent to understanding the embodiments. The presented embodiments are not intended to define limits as to the structures, elements or methods of the inventions, but only to provide exemplary constructions. The following embodiments are permissive rather than mandatory and illustrative rather than exhaustive.

The present invention discloses a non-obvious and unique system and method to manage contents of personal storage accessories, such as wallets, wristlets, watches, bands, purses or even luggage, and categorize financial information from a transaction or an element of a transaction using such contents.

Some embodiments of the present invention also manage all inventory of a personal storage accessory by automatically detecting when a specific content is stored or removed from the accessory and providing one or more notifications to the user. Personal storage accessories typically store payment cards, payment devices, identification cards, insurance cards and the like, collectively called “content” or “content-storing components” herein. The content-storing component is typically handed to another person, such as a merchant, to perform a payment or to transfer some information, for example. Unfortunately, the content-storing component, a payment card for example, may be forgotten and/or receipts related to the executed transaction may be lost, thereby hindering management of the content, which may comprise, for example, personal information, money, financial information.

In one embodiment, the present invention automatically detects removal of content and notifies the user when content has been removed and/or provides the user with information pertaining to a recent transaction.

For embodiments where electronics devices are removed from an accessory, a magnetic switch such as but not limited to a reed switch or a Hall effect switch detects removal of the electronics device, and/or other sensors including motion sensors such as accelerometers, gyro and the like, as well as proximity sensors such as but not limited to optical sensors and/or NFC (Near Field Communication). Hall effect sensors can be located to detect when a specific device, such as an electronics device, within an accessory has been removed and/or detect when an accessory containing the electronics has been opened. Hall effect sensors provide a better “sense” of a magnetic field that can be used to discriminate ambient fields created by EMF generating devices, such as but not limited to AC power lines, transformers, and the like.

According to this invention, electronics devices integrated within a personal storage accessory may be activated (turned on) when the electronics device senses a disturbance or change in a magnetic field when the accessory is opened.

In certain applications, an electronics device comprises a first sensor that is coupled (physically, mechanically, magnetically, motion, radio frequency, etc.) to a second sensor disposed on the accessory when the electronics device is stored within (a pocket for example) or stored on the accessory. When the electronics device, such as a transaction or payment card (typically having a relatively thin, and sometimes laminated structure) is separated from the accessory, the coupling arrangement between the device and the accessory is disturbed and either or both of the accessory and the device is activated (turned on).

Another aspect of the present invention comprises several non-obvious and unique methods and associated devices to automatically send, receive, store, retrieve, notify and display information pertaining to financial transactions or elements of financial transactions as executed by the content-storing component. Elements of financial transactions include but are not limited to individual items and their respective amounts in one or more currencies. As a non-limiting example, an element of a transaction may comprise a single item purchased at a grocery store that is categorized and/or “coded” as a food item purchase.

Financial information includes but is not limited to specific items that were purchased and their respective currency, amounts, item numbers, accounts, name of items purchased, descriptions, store name and/or locations, etc. Such financial information will hereafter be referred to as “financial identifiers” for short.

Financial identifiers may be used to determine and assign one or more financial categories to one or more transactions to represent financial codes, accounting codes, or transaction descriptors and the like. Financial transactions are typically categorized by sorting pieces of financial information into one or more different financial categories. Common financial categories may include but are not limited to expenses, travel costs, revenue, assets, liabilities, and the like.

In one non-limiting example, a user may make a purchase and as a result, the transaction will be automatically recorded to a specific category, perhaps even as related to the specific item purchased.

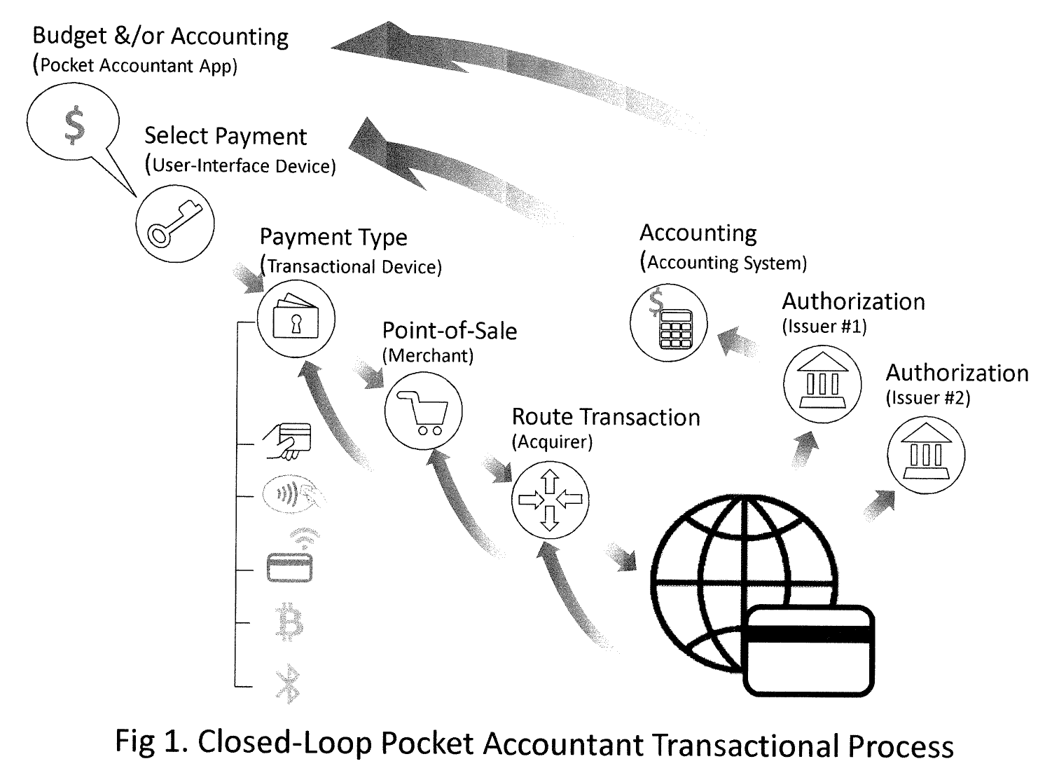

According to this invention, financial identifiers may be automatically or manually categorized and/or “coded” at various points along a transaction path, such as but not limited to the transaction path of FIG. 1. These financial identifiers can be acquired by a software application, perhaps referred to as a Pocket Accountant application (commonly referred to as an “app” or SDK (Software Developers Kit) for short), executing on an electronics device, a content-storing component, a user's device, a transactional device, a merchant's device, an acquirer's device, an issuer's device, a sending entity, a server, an intermediate accounting service, or a payment processor.

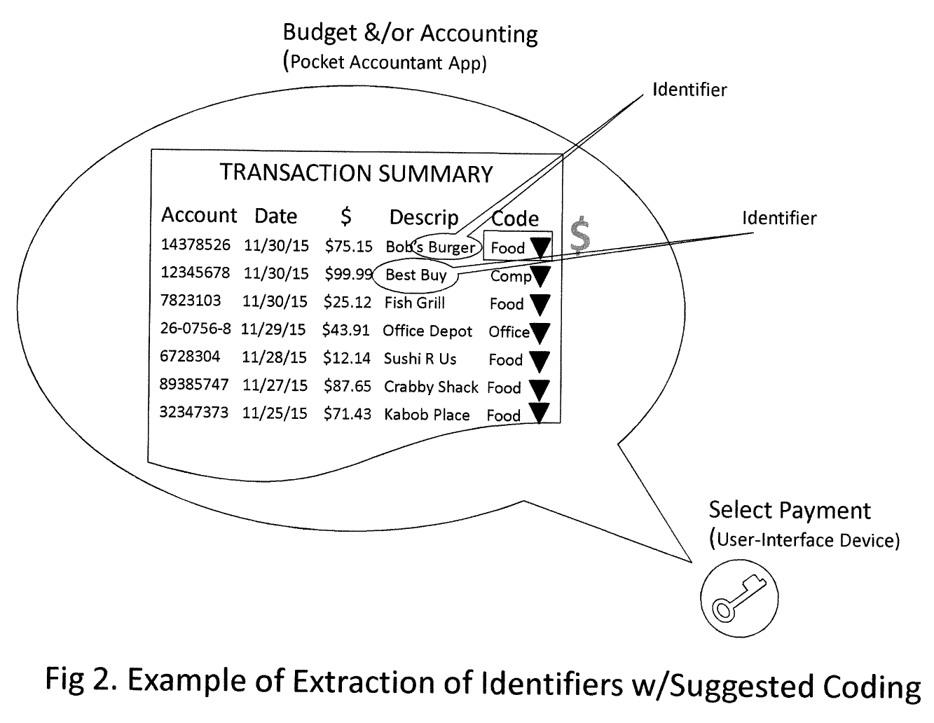

These transactions and their respective categories may then be recorded to accounting systems and/or software for later retrieval and management. Or the transactions may be communicated back through the transaction path to a user's device. The user may then be notified of the transaction audibly, visually (on a display) or by a vibration. The user can then retrieve the transaction and category information, as shown in FIGS. 1 and 2.

This invention employs a “closed loop” system, as the user initiates the transaction and receives information about the transaction. The same device can be used to both initiate the transaction and receive the information, or two different devices may be involved in the “closed loop” system. However, whether one or two devices are used, all the pertinent transaction data is under control of the user/owner of the data.

In some embodiments, categories may also include loyalty or reward information, such as but not limited to “points”. In such embodiments, the reward points may also be used to perform the transaction, or some combination of points and currency.

As a non-limiting example, the name of a restaurant, such as Bob's Burger in the example given in FIG. 2, may be used to categorize or “code” a purchase as the transaction is charged to an account. Given that the transaction occurred at a restaurant, the transaction may be coded as a food purchase. Likewise, the transaction may include reward information such as points, as well as currency, and one or more devices may receive the reward information from one or more other devices that are associated with the transaction.

As shown in FIG. 1, a user may select a payment on a user-interface device and perform the payment with a transactional device that interacts with the point-of-sale (POS) terminal at the merchant, for a non-limited example. The point-of-sale may send the transactional information to an acquirer, bank or financial institution that routes the information to the appropriate issuer for authorization.

Routing of the transaction information is typically based on the first four or six digits of a standard PAN (payment account number). In some embodiments, an alias and/or token may be transmitted in lieu of the actual PAN. The alias and/or token may then be decoded and/or translated to an actual account number as described in the commonly-owned patent application entitled System and Method for Low-Power Close-Proximity Communications and Energy Transfer Using a Miniature Multi-Purpose Antenna, filed Apr. 4, 2016 and assigned application Ser. No. 15/089,826 (Attorney Docket 12188-016).

As an issuer authorizes payment, the issuer, accounting system, cloud-based services and/or servers, and/or “Pocket Accountant” software on the user device may extract identifiers from the transactional information and categorize the transaction with one or more accounting codes, as in this example shown in FIG. 1. In another example, categorization could take place in the cloud, on a private computer, or on an app on a user device. Likewise, in other embodiments, financial information can be sent to a software application or a service that provides a budget, where the amount of a specific currency that was used for a specific account is tracked against the budget. For instance, under this permutation of the invention, a family can set spending goals or limits for each individual on a joint account, track expenditures for each individual, and record the number, amount, category, time, and other information related to transaction. Thus, a user may know how much she is spending for a given category or account, and how much his or her spouse, father, mother, and each child is spending for a given account or category.

Entities that may be able to send financial information to a user device include but are not limited to the retailer, the acquirer, the acquiring processor, and/or the issuer, called “sending entities” herein. Sending entities may utilize various techniques, devices, and networks including but not limited to a series of networks, databases, applications, software, communications paths, devices, algorithms, wireless protocols and/or payment methods to send financial information either directly or indirectly. Information may be sent to accounting systems, servers, software, computers and/or devices called “accounting systems” herein. Devices used by the entity to send financial information may include but are not limited to one or more of the following: a POS (Point of sale) system or terminal, a server, the cloud, computers, a hub or the like.

As payments are executed via any payment type or method chosen by the user, transactional information may eventually reach a payment processor, and/or a financial institution. APIs (Application Programmer Interfaces) and/or SDKs (Software Development Kits) enable applications to integrate, securely, with banks and other financial institutions, called “financial institutions” herein, that provide transactional information for a given account, user and/or payment method. Alternatively, the POS (Point-of-Sale) terminal and/or entry point for a transaction may send transactional information back directly or indirectly to applications on one or more devices or computer readable medium. Identifiers may be detected within the transactional and/or financial information at any point within the transactional process.

The system of the invention may consist of a stand-alone device or its functionality may be incorporated into one or more user devices whereby a user operating a user device may direct use of a payment account or a payment type. These user devices include but are not limited to smart wallets, phones, watches, wristlets, luggage, tablets, laptops, IoT (Internet of Things) devices, or any other non-limiting mobile, portable, static or wearable device capable of a user direction a financial transaction, collectively called “user-interface devices” hereafter.

Likewise, user-interface devices may also operate as dual purpose devices, such as payment and/or transaction devices, if they contain elements related to a specific payment method, or may be stand-alone transactional devices that receive direction from a user-interface and direct the payment account and payment method or payment type for a given transaction. Under such embodiments, the inventive techniques can reside in a stand-alone NFC (Near-Field Communications) wallet that may also serve to display a user identification, such as a photo, and other personal information, make transactions with bar codes, reward points, crypto-currencies, tickets, and the like, or may be an integrated transactional/user-interface device such as a smart wallet and/or a smart phone that supports both user-interface and transactional features such that multiple payments can be made.

Payments may be made using any interface, including any of the following: RFID (Radio Frequency Identification), NFC (Near Field Communications), BLE (Bluetooth® low energy), Bluetooth®, WiFi®, PAN (personal area network), 3G, 4G, bar code, 2D or QR code, magnetic stripe, Wi-Mag (Wireless Magnetic Stripe), EMV (Europay, MasterCard, Visa), sound and/or light.

Any device that can execute a financial transaction (such as a payment) may be referred to herein as a “transactional device.”

In one embodiment, dynamic transactions are supported by transactional devices. Dynamic payments may utilize one or more tokens so that the transactional information is dynamically changed with every transaction or is changed at after the lapse of various time intervals. Other implementations of dynamic payments that may be supported include sending transactional information over multiple “channels”, sending authentication information over one communication “channel” and payment information over a second “channel.” Dividing transactional and/or authentication information, for example, over two or more communication channels makes hacking and/or skimming of the transaction more difficult, since intercepting one “channel” yields only partial transaction information, which is inadequate for use by a hacker to conduct a subsequent transaction.

As a non-limiting example, a user may direct accounts, payment types (or interfaces) and/or categories for a transaction to be performed via a first device, a “transactional device”, by selection one or more accounts, transactional devices, payment types and/or categories from one or more second devices, or “user-interface devices”. The transactional device could, in this non-limiting example, transmit a token obtained from a remote server, cloud or the like, and sent to the POS (Point-of-Sale) terminal. Alternatively, a token could be dynamically generated for a given account from a multitude of accounts within the electronics on the personal storage accessory. In one embodiment, the personal storage device can be a smart wallet or a smart phone.

In yet another example, the transactional device may divide and send parts of transactional information over multiple communication “channels” such as NFC and BLE. In yet another example, authentication information is sent over WiFi® channel, while one or multiple parts of the transactional information may be sent over one or multiple other channels.

In some embodiments, the payment could be directed to another instrument that is configured to act upon the approval of the user, such as a robotic device, card or NFC tag, to act as the transactional device. In such embodiments, the transactional device is provided with the appropriate credentials to perform some transaction upon the user's behalf. In other embodiments, the user-interface device and the transactional device are integrated into a single device, such as a smart wallet, smart card, or other devices that can support both the user-interface and a transaction.

In yet other embodiments, one device, such as a smart wallet or smart phone, could perform the transaction using one payment vehicle, such as NFC or Wi-Mag, while another device, such as a card, could perform the transaction using another payment vehicle, such as EMV (EuroPay MasterCard Visa) contacts or a magnetic stripe on the card. In this non-limiting example, the smart wallet or smart phone could provide credentials to the transactional device operative with the card, while the smart wallet or smart phone could serve as the transactional device for NFC payments.

As a non-limiting example, a PAN (payment account number), token and/or alias can be selected and sent from a second or subsequent device to a first device, such as an NFC tag on a card, where the NFC tag on a card could receive the PAN, token and/or alias, and make the payment transaction. In such a permutation of the invention, the NFC tag on the first device, a card in this non-limiting example, becomes a transactional device in the form of an NFC payment device. After a payment has been made, information on the NFC tag may erased.

If a transactional device already has a specific payment type, such as but not limited to NFC, transactional information may be sent to the transactional device from one or more other devices. Likewise, the invention may recognize the NFC during scanning or “polling” of NFC devices within range of the electronics inside the accessory or apparel.

This concept is scalable to any number of devices and accessories as a user desires, where one device act as the “vault” for all private information and “directs” payments to other transactional devices. Alternatively, the “vault” can be distributed across multiple devices (a form of distributed security) to aid in maintaining the data private.

Data that may be stored within the secure “vault” may include but is not limited to, payment information (credit/debit/bank/etc.), loyalty information, insurance information, identification information, voting information, medical information and the like. Transactions may support and/or utilize such non-financial information (as well as financial information as described herein).

Any data that is typically stored in a personal storage accessory can be stored within the electronics of the accessory by inputting the data from (but not limited to) a card reader, a bar code reader, a picture, an OCR (Optical Character Reader), by voice recognition, sign language and/or a key entry interface.

Data stored within the vault (electronics) may be secured via encryption and only accessed by the owner of the data, e.g. the user. Authentication can be performed in a variety of ways including multi-device proximity detection, where multiple devices, such a phone and wallet, or keychain, phone and wallet, etc., must be present before a user may access or perform some action with any one device.

Other methods associated with the present invention include detection of which transaction account and/or device was used for a given transaction. This detection system not only bolsters the ability to track which device or account was used for which transaction but may also prevent loss and further fraud.

Data may also be protected as stored in the electronics using one or more multi-factor authentication techniques that determine that the user is who he/she says he/she is such as but not limited to biometrics, behavior-metrics, electronic-metrics, PINs (Personal Identification Numbers), and/or passwords. Such multi-factor authentication to access data on the electronics further increase fraud prevention techniques as well as detect the identity of the person at the point of transaction for proper account categorization and other “pocket accountant” preferences.

A user may combine selection of the payment account, payment type, loyalty, reward or other information with selection of a financial category. For instance, a user may “direct” a payment to be performed from a specific account and/or payment device and/or payment type and/or payment category by simply speaking a word or phrase that the user has associated with each. Loyalty information and “points” for reward programs and the like may also be transferred to and from the electronics, along with the payment account, payment type, and payment account as a user speaks a specific word or phrase. Such “biometric-directed payment” methods and systems are described in the commonly-owned provisional patent application entitled Sound-Directed or Behavior-Directed Method and System for Authenticating a User and Executing a Transaction, filed on Feb. 10, 2016, and assigned application Ser. No. 15/040,984 (Attorney Docket Number 12188-015).

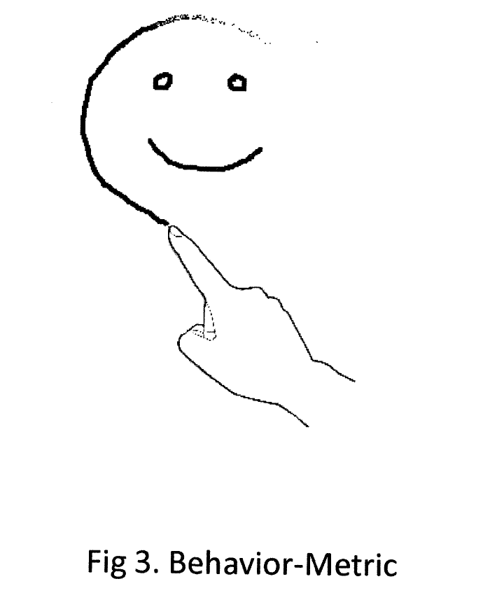

Likewise, in another non-limiting example, a user may simply perform some behavior or gesture such as drawing a shape on a touch screen (see FIG. 3), waving a hand, gesture or some other behavior that is also associated with a payment account, device, category or transaction type. Such “behavior-directed payment” is described in commonly-owned provisional patent application entitled and Biometric, Behavioral-Metric, Knowledge-Metric, and Electronic-Metric Directed Authentication and Transaction Method and System, filed on Jul. 5, 2016, and assigned application Ser. No. 15/202,515 (Attorney Docket 12188-019).

In yet another example, the invention may receive a Bluetooth beacon signal that suggests a specific payment or loyalty account and/or card, or in some embodiments, an advertisement. In the latter case, the personal storage accessory, the content-storing component, or a transaction device responds in some fashion to the advertisement, such as, for example, by notifying a user of the advertisement. In some embodiments, the user may choose to purchase whatever was advertised to one or more of the devices in response to one or more products advertised. In other embodiments, the beacon may provide notification to one or more devices that rewards or other gifts are available, and may transfer reward points to one or more devices.

Likewise, electronics within the accessory may send a beacon and/or BLE communication advertisement upon entering a store requesting all advertisements and suggestions for payment, loyalty, and the like.

In all instances, the payment transaction may be detected by motion of one or more devices. The act of motion of one device may, in some embodiments, enable the transaction on the transaction device.

In addition, electronics within the accessory may interact with a second device, a user-interface device such as but not limited to a cell phone, that in turn interacts with the store or establishment via WiFi®, BLE, NFC or some other communication method support services such as suggestion, approval and transfer of payment, loyalty, reward, advertisement, and other information. Such interaction between electronics within an accessory and a merchant, business or equivalent is described in patent application entitled Personalized and Dynamic Tokenization Method and System, filed on Jul. 14, 2016 and assigned application Ser. No. 15/210,728 (Attorney Docket 12188-020).

Categorization or “coding” of transactions (in particular financial transactions, or elements of a financial transaction) may be completed either manually or automatically by any of the user device/application or by the one or more of information-sending entities. In one non-limiting method, one or more transactions or portions of transactions are routed to a server whereby one or more identifiers are automatically derived, coded and sent to an accounting system, such as but not limited to QuickBooks, and/or to a spreadsheet application such as Excel. In another non-limiting example, one or more transactions or portions of transactions are routed to software on a user device, so that the user may see a record of the transaction as the transaction takes place, and its associated categories and other information (such as but not limited to financial balance). In some embodiments, a user application and/or transaction device records the transaction information locally such that a user may download the information to another accounting system whenever the user wishes.

In some embodiments, one or more numbers, letters, and/or characters within an identifier may be utilized to identify the correct accounting category for the transaction or portion of the transaction. If a sending entity categorizes the transaction or a portion of the transaction, as in some embodiments, then the sending entity may indicate the category to a user device, application, software or service. In other non-limiting embodiments, one or more identifiers may be used by one or more user devices and/or applications to categorize each transaction or portion of a transaction automatically. If a situation arises where automatic categorization may not be possible, then a user may choose the category for the transaction manually from suggested and/or a list of categories, and/or enter all financial information related to one or more transactions manually, and categorize manually.

Under such “manual coding” embodiments where the user selects or enters one or more categories, the encoded transaction may be sent to an accounting system local to a consumer device, or on another device or server for further processing and record keeping. In some embodiments, the category, amount of transaction, or other identifiers may determine the account or currency used in conducting the transaction. As a non-limiting example, a transactional device may be used at the POS terminal to complete the transaction at the merchant level, but a server-side system may determine the category or amount of the transaction, as well as the transaction account to be charged. This same system facilitates endpoints that can determine the available balance in each account or payment system. This information may also be passed down from a server and displayed on a transactional device such a smart wallet and/or card, or mobile device such as a smart phone. In conjunction with this patent's “pocket accountant” methodology, transactions, accounts, balances, overdraft alerts, and spending charts may also be displayed on a transactional or another device.

Under one embodiment, a transactional device, or one or more devices that direct and/or retrieve information from a transactional device, may also track and/or display spending as financial transactions occur. Spending may be tracked per account, card, accounting code, location, and/or other category, for example, as well as balances, budgets, overdrafts, and/or other financial information on a per account or card basis.

In certain embodiments, the location of the transaction may be recorded, using beacons that communicate the name of the store with one or more devices, triangulation and TDOA (time difference of arrival), Doppler, GPS (Global Positioning System), or other geolocation techniques.

One feature of certain embodiments autonomously routes (without user intervention) coded transactions to accounting services, software or systems. In one method of the present invention, this may be achieved through the sending of one or more codes to the mobile device. Such codes may be referred to herein as “identifier codes.” Identifier codes may include letters, numbers, symbols, or any other non-limiting characters called “indicators” hereafter. In some non-limiting embodiments, identifier codes may consist of polynomials of one or more characters. The identifier codes described herein may contain or comprise one or more identifiers from a number of sources, including but not limited to an inventory management system. Identifier codes may also include but are not limited to SCC's (standard classification codes). In other non-limiting embodiments, an identifier code may be a translated and/or represented by a cryptogram or token. The routing of these coded transaction may or may not be encrypted.

In some non-limiting embodiments, an entity including but not limited to the retailer, the acquirer, the acquiring processor, and/or the issuer, may produce the identifier code. Identifier codes produced by one or more entities may be sent to one or more other entities for verification, authentication, sending and/or recording of the identifier code. However, in some embodiments, the identifiers may be sent from one or more entities to one or more different entities for the development of the code and/or further categorization into subcategories, such as a code in an office supplies subcategory.

The identifier code may contain only one indicator as in some non-limiting embodiments. However, in other non-limiting embodiments, the identifier code may contain both the indicator and additional identifiers. Such identifiers may be used for validating the indicator on the user end.

Financial identifiers such as item numbers and/or names of products may be sent to a user interface from a server, device or other entity, whereby a user may manually enter or select the financial category. In some embodiments, the device, software, service and/or application may suggest a financial category to the user. The user may then accept, reject, or change the suggestion.

Certain of the various described embodiments refer to a user interface. As those skilled in the art are aware, many different devices can provide that interface and the specific type of interface, e.g., sound, speech, touch, behavior, key strokes, gestures, can be provided on any such device.

The financial category to be assigned to a financial transaction may be communicated to the assigning device directly from a user via a user interface, from a software application, from a device, or from another entity. In some embodiments, a user may select the category from one or more categories set forth on a display screen interface, further comprising buttons or a touch screen to perform selection. The interface may be present on a wearable device, such as a smart watch, or a mobile device, such as a smart phone, or another device, such as a smart wallet.

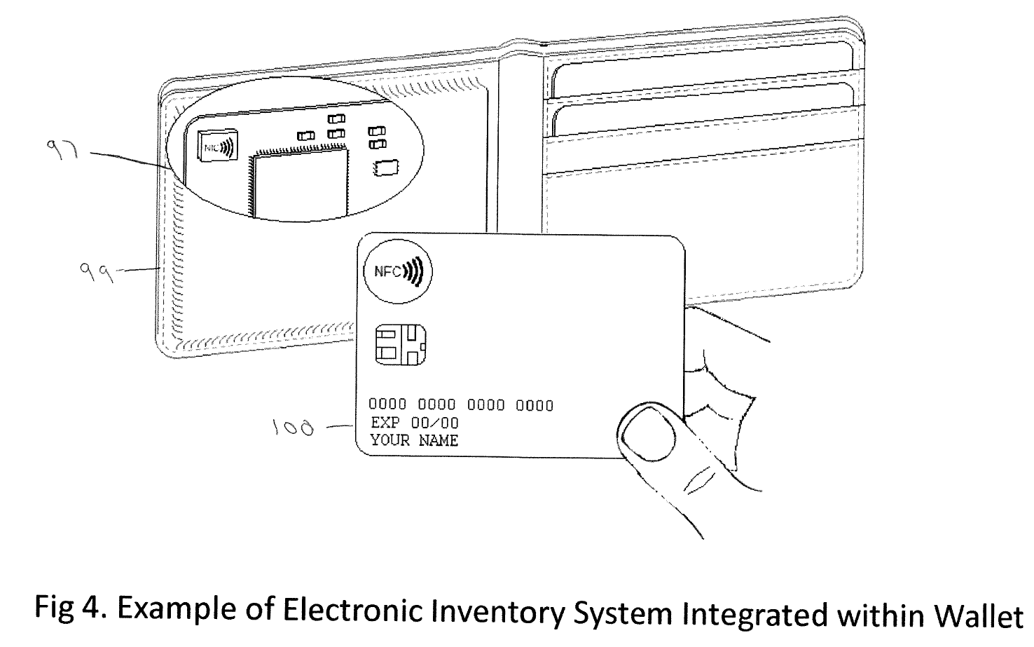

In one embodiment, this invention implements an inventory management system that organizes and keeps track of all contents in a wallet or other portable, mobile and/or wearable apparatus (e.g., a personal storage accessory). Apparatuses are designed to hold contents, such as hand bags, storage bags, peripherals, leather goods, wristlets, purses, watches, wallets, luggage and other personal storage items collectively called an “accessories” or “personal storage accessories” herein. In some embodiments, electronics are integrated within the material of an accessory. See FIG. 4 where components 97 of the inventory management system are contained with a wallet 99. To inventory the contents, each item added to or removed from the accessory, such as the card 100 of FIG. 4, includes electronics for communicating with the smart wallet 99. Adding electronics to an accessory is described in detail in the commonly-owned patent application entitled Method for Replacing Traditional Payment and Identity Management Systems and Components to Provide Additional Security and a System Implementing said Method, filed on Oct. 8, 2013, and assigned application Ser. No. 14/049,175.

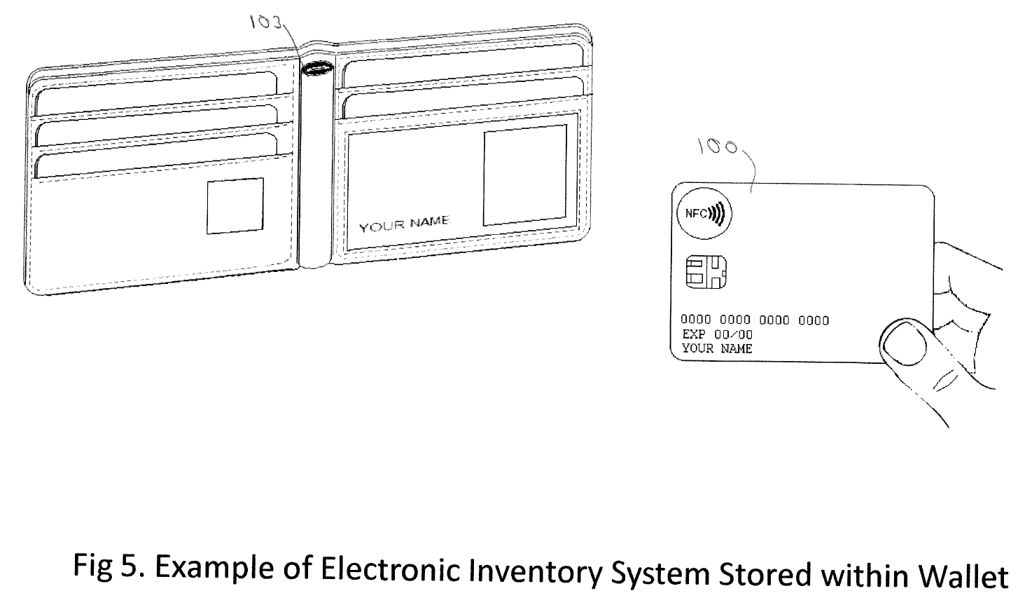

In other embodiments, electronics could be contained as a separate peripheral device 103 that can be held within the envelop, material or enclosure of the accessory, as shown in FIG. 5.

In some embodiments of the invention, electronics may contain a sensor that can detect all contents contained or stored within the accessory. Mechanisms that enable electronics to monitor contents within an accessory include but are not limited to RF-based proximity sensors like RFID (Radio Frequency Identification) or NFC (Near Field Communications).

For a non-limiting example, “tags” can embody NFC stickers that a user may add to each content, such as cards, within a second device, such as a wallet. Each NFC tag may possess a number or code that uniquely identifies the NFC tag. Under this method, each NFC tag is read by a reader of the electronics within the wallet or within a separate device stored within the wallet. In one example, when the tag is “read” the electronics within the wallet is activated and/or the content-storing component is activated.

A user may correlate each NFC tag to an account, insurance card, identification card, loyalty card, or virtually any content typically found within a common wallet, via an app on another device that communicates with the electronics within the wallet. As the wallet is opened and a card is removed, the electronics is turned on and immediately reads all NFC tags within the wallet. As each NFC tag is recognized by the reader, a “halt” or equivalent command can be sent to the NFC tag as the next tag is read. In this non-limiting example, all NFC tags may be detected upon activation of the electronics (powering/turning on).

As one or more of the contents or content-storing components is removed, the electronics again reads what NFC tags are within range to determine which contents are within the accessory. The electronics could read (or scan) based on various methods including but not limited to a time interval, or in some embodiments, some trigger such as but not limited to a user performing the action of removing content, pressing a button or tapping the accessory as an accelerometer detects the tap.

Since the NFC tags are within close proximity to the reader within the electronics somewhere inside a relatively small personal storage accessory like a wallet for example, the reader is able to read the content storing component within NFC range. In some embodiments with more space within the accessory, the NFC tags may need to be affixed to the content storing components at specific locations on the component. In other embodiments, a sensor technology with an increased detection range, such as RFID (Radio Frequency Identification) or BLE (Bluetooth Low Energy) may be employed.

This mutual inter-awareness method to detect the presence of one or more devices by one or more other devices can be expanded to devices outside the accessory such that multiple accessories can be detected by one another. For a non-limiting example, a small, low-power BLE tag can be attached or integrated within various inter-aware devices so that if one is not present, one or more of the other devices could notify a user or entity.

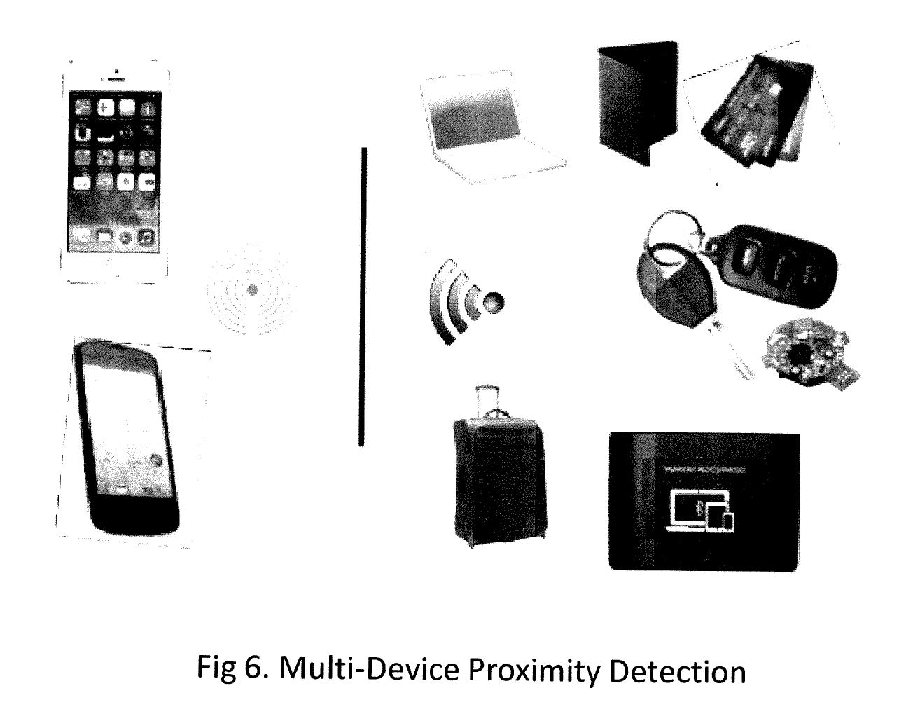

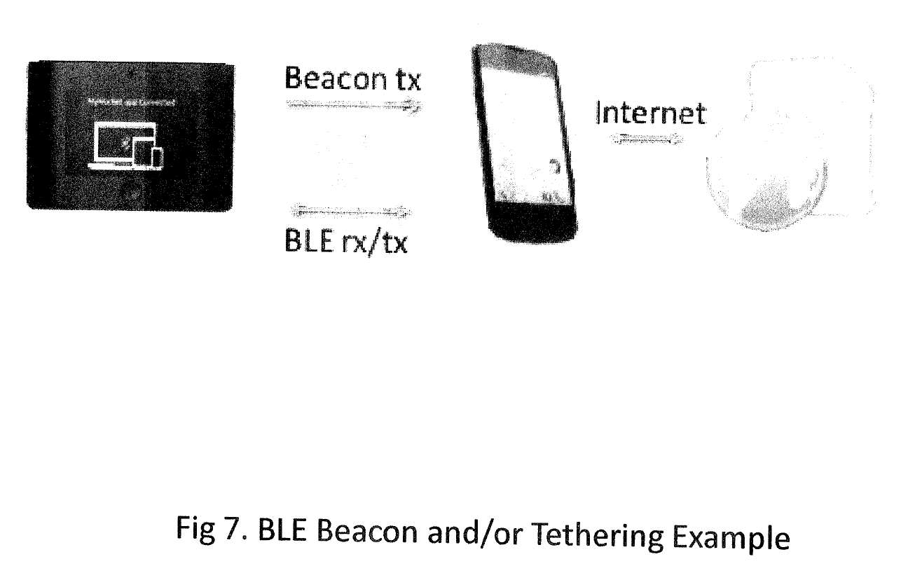

As shown in FIG. 6, BLE tags, and/or other communication interfaces that have low power requirements and can be placed anywhere, may generate beacons or other communications signals to locate one or more accessories from one or more other accessories. Communications such as but not limited to BLE beacons enable devices to not only locate other devices when within range of a beacon, but also enable connectivity via BLE communication advertisements, tethering or other methods to access the internet as shown in FIG. 7. Devices may include, but are not limited to key chains, watch bands, phones, wallets, wristlets, luggage, laptop/computers, tablets, smart phones, cards and the like. In this non-limiting example, BLE device on a phone can monitor, for example, to determine the presence of, a laptop, wallet, credit/debit cards, key chain, dongle, smart wallet, luggage, tablet and/or another smart phone. Devises that connect in this manner are called “intelligently connected devices”, since they only connect to the internet, either directly or via one or more other devises, when they need to, which reduces power consumption and improves security.

For instance, one or more devices may utilize beacon technology to wake-up an app from the background for delivering IoT data. This wake-up is advantageous to keep users from having to start the app manually, which may be cumbersome. Under this embodiment, an operating system (OS) may track beacons and inform the app whenever one enters or leaves a proximate region. If a device wants to make an IoT request, it will start broadcasting as a beacon with a certain UUID (Universally Unique Identifier). Other devices and/or accessories may receive the beacon and launch the app to support the IoT session. In this way, an entire IoT session may be handled in the background, never requiring launch of the app to the foreground.

Users-interface devices, such as smart phones, key chains and/or smart wallets, may then alert users when any necessary devices are missing. GPS tagging, triangulation, TDOA (Time Difference of Arrival), RF Doppler are non-limiting examples of methods to determine the last known location and may enable the app to help the user find any missing devices.

Other examples include IoT (Internet of Things) devices, where increased range between devices may require longer range RF (Radio Frequency) wireless technology such as WiFi® and/or PAN (Private Area Network) or even 3G, 4G, or LTE. This invention is interface agnostic, and can utilize any interface that can be utilized for short, medium or long range accessory and/or device inter-awareness. Inter-awareness may also include authentication, as described in the commonly-owned patent application entitled Universal Authentication and Data Exchange Method, System and Service, filed on Mar. 17, 2014, and assigned application Ser. No. 14/217,289. This method of inter-awareness via proximity detection is described in detail in the commonly-owned patent applications entitled Universal Authentication and Data Exchange Method, System and Service, filed on Mar. 17, 2014, and assigned application Ser. No. 14/217,289; A Method and System to Validate Identity Without Putting Privacy at Risk, filed on Sep. 1, 2015, and assigned application Ser. No. 14/842,252; and Method for Replacing Traditional Payment and Identity Management Systems and Components to provide Additional Security and a System Implementing said Method, filed on Oct. 8, 2013, and assigned application Ser. No. 14/049,175.

Another embodiment of this invention includes the capability to detect whether an accessory is sitting on a table, worn on a person, or in a user's pocket. In such embodiments, various states are detected, such as temperature and movement. The delta or difference between temperature while an accessory is worn or carried can be calculated versus temperature while an accessory is not carried or worn. Likewise, an algorithm can track the pattern of usage over time by detecting movement with an accelerometer. Thus, according to this method, an accessory can be detected as worn by a person, in a person's pocket, setting on a table, or in another state.

Electronics within accessories can, in some embodiments, be configured to monitor each of the other accessories such that it may notify the user if any one of the accessories is not present. In this way, no accessory would ever be left behind without the others, and all of the accessories could notify the user of a missing accessory. In this sense, one or more devices may act as an inventory management system for one or more other devices. This mutual understanding of where devices are relative to one prevents one from leaving an important device behind.

In one embodiment of this method and system, the accounting category may be detected while also detecting the physical presence or absence of a payment card (or “card present”). That is, when a user physically removes a first device, such as a transaction device or a transaction card, from a second device, such as a user interface accessory device, then utilizes the first device to perform the transaction, the accounting category is determined from the category associated with the first device. As a non-limiting example, a user may associate a first device, such as payment card to a specific account via software on a second device, an app on a mobile or wearable device or a smart wallet, for example. When the user removes the first device from the second device, the latter detects which card was removed and “knows” the accounting category associated with the removed first device, Thus the use of the card and the account categories associated with that card is recorded.

Alternatively, the second device can communicate this information to a third device, such as a smart phone, computer or server, or tether to one of these devices to send information to a fourth or subsequent device, a server, cloud or other service for example, via the third device's internet connection.

The system can be further configured such that the user receives notifications for certain events, such as but not limited to every transaction; intervals between transactions; transactions related to a specific account, category, individual, or business. The timing of the notifications can also be determined by the user, such as at specific times of the day, on specific days, at the end of the day. Immediate alarms can also be triggered based on certain transactions. An alarm can also be triggered if the nature of the transaction does not correlate with the transactional device (card) that was removed from the accessory (smart wallet). This method improves security against identity theft with near real-time notifications of transaction activities.

In one aspect of this invention, the removed first device (the transaction card) could be detected as missing using proximity detection technology. After some period of time, which can be a user defined parameter in one embodiment, the second device, having a proximity detection feature, can transmit a message or alarm indicating that the first device is missing. The message may be presented on a visual display, or may activate a vibration or sound on the second device, or alternatively, on a third device. Likewise, any second, third or subsequent device can notify the user or notify another device that one the first device is missing.

Under these embodiments, one device may notify a user than another device is not present, either immediately or after a time duration. Thus, under these embodiments, a device, such as a wallet, would never be left unattended without notification to the user by another device, such as a cell phone, or vice versa. Details of mutual proximity detection of mobile and wearable devices are described in the commonly-owned patent application entitled Method for Replacing Traditional Payment and Identity Management Systems and Components to provide Additional Security and a System Implementing said Method, filed on Oct. 8, 2013, and assigned application Ser. No. 14/049,175 and in the commonly-owned patent application entitled The Un-Password: Risk Aware End-to-End Multi-Factor Authentication via Dynamic Pairing, filed on Mar. 17, 2014, and assigned application Ser. No. 14/217,202.

Methods to detect another device include but are not limited to aforementioned RF (Radio Frequency) based solutions as well as optical based solutions, active sensor methods, and physical or electronic switches. RFID, NFC, BLE and other RF-based technology may include RF and some memory within or affixed a first device to identify the device. Devices could also be paired with one another using various pairing code methods, or in some instances, dynamic pairing such as but not limited to that described in patent application Ser. No. 14/217,202 as identified above.

One non-limiting example of RF based proximity detection is applying an NFC tag to a payment card. Under this example, the NFC tag affixed to the card is detected to be within a second device, such as a smart wallet or phone. When the card is removed, the NFC tag for that card is no longer detected, and the category associated with that card is notated.

Optical based solutions such as infrared (IR), near-infrared (NIR), and/or photodiodes may be used to detect cards within close proximity to the sensor.

Active sensor methods such as capacitive, resistive, inductive and/or conductive with physical contacts may also be used to detect if a card is present or removed. Like RF-based detection, active sensors may benefit from the use of stickers or material, such as materials made out of metal, added to the card to enhance detection. But unlike other proximity detection methods described herein, this method requires a card to be inserted into the same slot if that specific card is to be detected. A card may not be detectable if it has been inserted into any slot or location within a wallet or another storage device.

Sensors may be placed along edges of a location where the card may be stored. For instance, a magnetic sensor could be disposed along a bottom or sides of a pocket, along a front and/or back of material, and/or stitched into an edge of a material. Alternatively, other sensors such as NFC or optical proximity sensors (non-limiting) could be placed at one or more of the corners of a pocket. The sensors may also be readers that are disposed somewhere within the material of a mobile device cover, such as a cell phone, or the material of a smart wallet.

Other embodiments of active sensors include sensors that detect plastic or magnetic stripes, (with the latter still present on many transaction cards today). Some embodiments may include sensors that detect metal, such as metal within a card and/or metal contacts from “chip and pin” (also referred to as EMV cards) physical contact cards.

Other detection methods include physical or electronic switches that detect if an object is inserted into a specific pocket or slot. Like active sensors, physical and electronic switches cannot detect a specific card in a slot. Instead, a physical switch disposed in a slot or pocket detects the presence of a card, but has no means to detect which card. Likewise, electronic switches, such as but not limited to magnetic switches, detect the presence of a card, but again cannot detect details associated with the card. As a card is removed, contacts and/or magnets close (or in some embodiments open), a circuit that in turn signals a microprocessor that a card is no longer present in the slot or pocket.

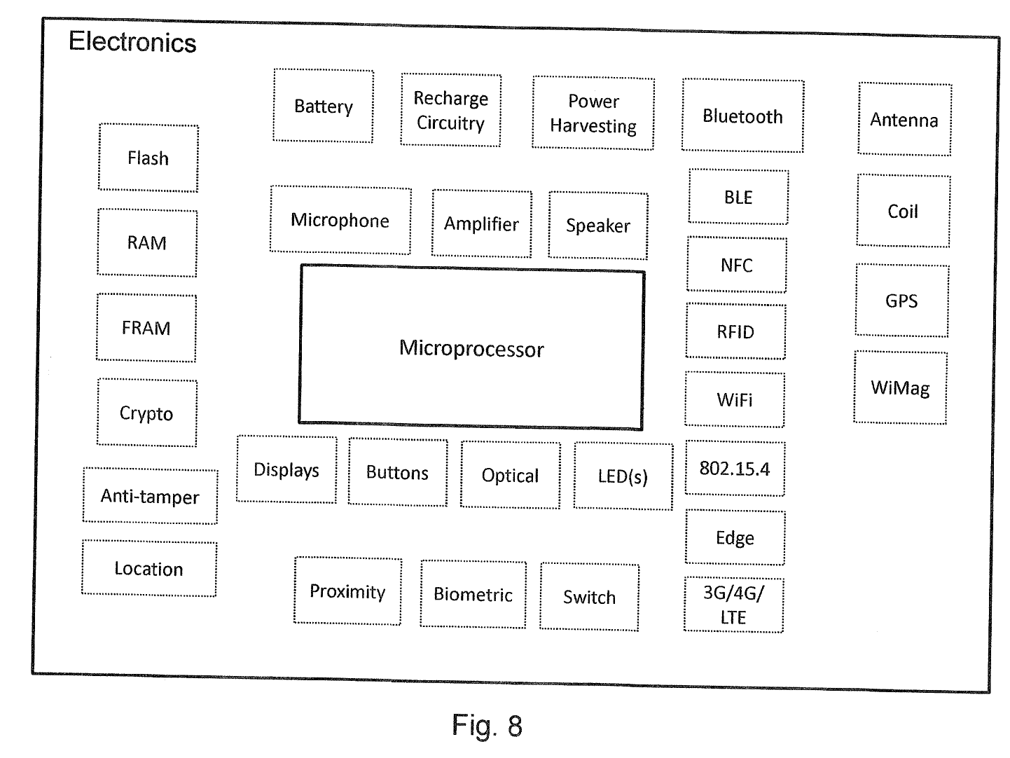

For all these methods, electronics within the smart wallet are needed to detect the presence or absence of a transaction device, such as a transaction card. Electronics may include one or more of the following to detect and/or send a signal based on the detection or absence of the transaction device: flash memory, RAM, FRAM, crypto, anti-tamper devices, location devices, battery, recharge circuitry, power harvesting, microphone, amplifier, speaker, displays, buttons, optical sensors, LEDs, proximity sensors, biometrics, switches, Bluetooth, BLE (Bluetooth Low Energy), NFC (Near Field Communications), RFID (Radio Frequency Identification), WiFi®, 802.15.4, Edge, 3G, 4G, LTE, GPRS, antennas, coils, GPS, WiMag, etc. Certain ones of these devices are shown in FIG. 8.

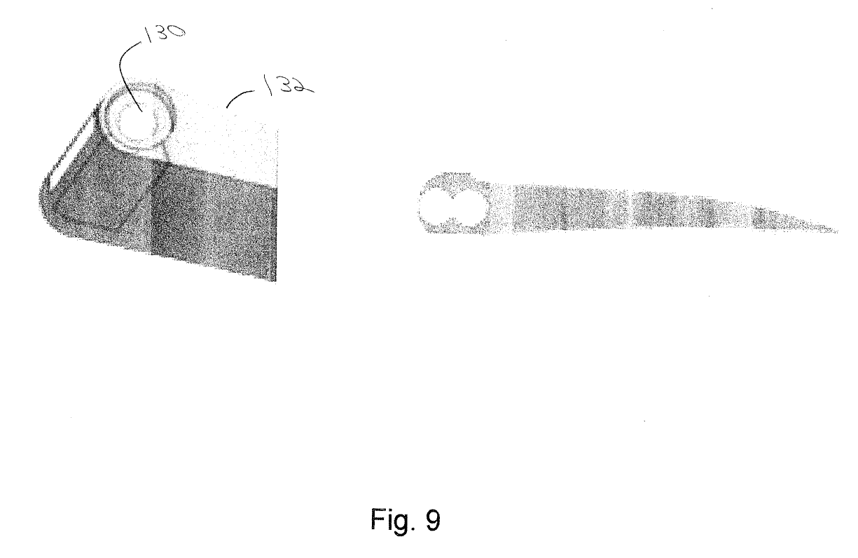

One or more batteries may also be used to charge a cell phone. A battery slot 130 can carry a replaceable or rechargeable battery. The battery can also be disposed in a seam of a typical soft material or hard shell wallet 132 as shown in FIG. 9.

Likewise, a battery within the accessory may also serve to charge another device, such as a cell phone with a USB connector.

In some embodiments, the electronics may be integrated within a wallet. In other embodiments, the electronics will be disposed in an accessory that can fit within a conventional wallet. Methods to integrate the electronics include those described in the commonly-owned US patent application entitled Components for Enhancing or Augmenting Wearable Accessories by Adding Electronics Thereto, filed on Sep. 2, 2015, and assigned application Ser. No. 14/843,930 (Attorney Docket 12188-025).

Since many tags, such as NFC tags, may be passive, no battery is required, although batteries or power sources with energy harvesting are beneficial in some embodiments. As a user opens a wallet, the electronics may be configured to automatically turn on, or could be turned on via a button or equivalent switch. In some embodiments, users may tap to turn on where an accelerometer or equivalent low power sensor detects a user's tap. In some configurations, a double tap activates proximity detection and determines what other devices are missing via proximity detection.

In some configurations, proximity location can be activated, where one device acts as a locator for another device. For a non-limiting instance, a phone could be used to find a wallet, wristlet or key chain, while in another example a wallet could be used to locate another wallet or keys. Methods that are used to locate another device include methods that measure the power and/or direction of the power using TDOA (Time Difference of Arrival), RFDOA (Radio Frequency Direction of Arrival) and/or triangulation between devices.

Other methods, such as use of a magnetic switch or equivalent, may be used to turn the electronics on and off (in the off state the electronics consume zero power). In one such embodiment, electronics are turned on and off by controlling a configuration of a reed-switch. For example, the electronics is held in an off state when a magnet closes the reed switch. The magnet can be attached to a surface of an accessory to close the reed switch that is disposed within a pocket, lining, or material of the accessory. In another example, a magnetic sticker may be added to an area of the accessory that corresponds with the position of the reed switch. As the sticker is moved away from the magnetic reed switch, for example, by physically opening the wallet or accessory, the switch opens and turns on the electronics. The advantage of such an implementation is that it consumes no power while the reed switch is closed, but turns on the electronics as the switch is opened (as the magnets are separated by the action of opening one side of the accessory (possessing a magnet or magnet sticker) relative to another side of the accessory (with the electronics housed in or near the other side of the accessory Those skilled in the art will recognize that in another embodiment the switch can be configured and located to turn on the electronics when closed.

One device may send payment credentials to another device to perform the transaction. Under such embodiments, selection of an account, payment type, or transactional device may take place on a user-interface device, while the actual payment may take place on the transactional device. Using the previous example of NFC stickers or “tags”, a user-interface device, such as a phone or smart wallet, could send payment credentials, such as a token, down to the NFC tag to perform transactions.

For instance, the user-interface device could be a cell phone while a transactional device could be a smart wallet. In another permutation, the smart wallet could be a user-interface device, while a dynamic card within the wallet could be the transactional device. This interdependency between multiple devices for both proximity detection and/or payment is described in the commonly-owned patent applications: Method for Replacing Traditional Payment and Identity Management Systems and Components to Provide Additional Security and a System Implementing said Method, filed on Oct. 8, 2013, and assigned application Ser. No. 14/049,175 (Attorney Docket 12188-001), and Distributed Method and System to Improve Collaborative Services Across Multiple Devices, filed on Feb. 8, 2016, and assigned application Ser. No. 15/018,496 (Attorney Docket 12188-014).

As described in this patent application, payments may be proximity controlled, meaning no payments may take place unless any two devices are present. Likewise, one device may be used to find any one of the other devices, as well as send an alarm and/or notification to the user or to another device to notify the user that a device is missing.

Any device can become a transactional device via methods such as but not limited to HCE (Host Card Emulation) whereby the device finds a path to the internet to negotiate and download tokens from cloud services. The path to the internet could be via an RF interface, such as BLE (Bluetooth Low Energy) as one non-limiting example, to another device via tethering and/or a software app, and/or directly to the internet via WiFi or another wireless interface. Alternatively, the device can possess a Secure Element (SE) local to the device or from another device that generates a token via standard EMV tokenization algorithms, or other 3^{rd} party token algorithms, within a “multi-tokenization” method that support multiple token generation from the same platform.

In some embodiment, electronics may contain an accelerometer or equivalent motion detection, collectively called an “accelerometer” herein. The accelerometer may serve as a wake-up trigger, an authentication device, a gesture detection device, a behavior detection device, and/or a controller device.

As an accessory containing electronics with an accelerometer moves, the accelerometer could wake up the electronics by sending a single to a microprocessor. In addition, movement at a specific speed, direction or patterns may also awaken the electronics.

Likewise, movement in a certain speed, direction and patterns could serve to act as a user authentication act or a “behavior-metric”. Under certain embodiments, a user can be authenticated by drawing a predetermined pattern in the air and detection of that pattern. The user may also be authenticated or the user's identity determined based on how the user performs each control or the manner in which a user uses the device can also be used to authenticate that individual. Under such embodiments, the user may train the algorithm by repeating the movement in the air during a training process, where the movements are captured and mathematically modeled. The algorithm can then distinguish movements in the air of a legitimate user from movements of unauthorized user.

In addition to using certain user movements or gestures for authentication purposes, a gesture or even movement of an accessory can be detected and serve to direct a specific payment account, payment type, or some other transaction as described in detail in the commonly-owned patent application entitled Biometric, Behavioral-Metric, Knowledge-Metric, and Electronic-Metric Directed Authentication and Transaction Method and System, filed on Jul. 5, 2016, and assigned application Ser. No. 15/202,515 (Attorney Docket 12188-019).

In addition, movement of the accessory could also serve as a controller for one or more IoT devices such as but not limited to televisions, stereos, lighting/illumination, fans, air temperature and the like. For a non-limiting example, rotation detected in the forward and reverse direction (about the x axis) may be interpreted as volume control, while rotation in the clockwise and counterclockwise (about the z axis) may be interpreted as channel control. Likewise, rotation in the left and right directions (about the y axis) may be interpreted as device selection.

Users may configure the device to interpret the meaning (and device response) of each movement and/or sequence of movements. For instance, a user may wish to activate controls only after authentication. Other users may configure (or train an algorithm) to recognize and authenticate an individual from the control motion itself. Movement could also mean other things or interpret other controls, depending on implementation and user configuration.

Electronics could be powered by one or more non-rechargeable batteries (such as but not limited to AA, AAA, or CR-2032), other “coin cell” batteries; rechargeable batteries, (such as but not limited to lithium-ion or lithium polymer batteries), a super capacitor, or another power source. In some embodiments, the battery could be placed within the seam of the wallet as described in commonly-owned patent application entitled, Systems and Device for Wireless Charging of a Powered Transaction Card and Embedding Electronics in a Wearable Accessory, filed on Sep. 2, 2015 and assigned application Ser. No. 14/843,925 (Attorney Docket 12188-024). This same battery could be used to recharge another wearable device, such as a cell phone, as described in the commonly-owned patent application entitled, Components for Enhancing or Augmenting Wearable Accessories by Adding Electronics Thereto, filed on Sep. 2, 2015 and assigned application Ser. No. 14/843,930 (Attorney Docket 12188-025).

Some embodiments may include a recharging mechanism such as but not limited to USB, contacts, or other physical wire or method of recharging that involves some connectivity with the electronics or recharging circuit associated with the power source. Other embodiments may include a wireless recharginng method, such as but not limited to one or more coils for inductive charging from another coil or charging pad. In some embodiments, the electronics and/or accessory may include one or more energy harvesting features such as but not limited to solar panels and/or energy harvesting from RF or by piezoelectric sensing.

Other features within the electronics include cryptographic components that support authentication, encryption, description, and/or key management. Within embodiments that include a crypto feature, end-to-end authentication may be achieved using symmetric, asymmetric, and/or combinations of symmetric, asymmetric encryption, and/or other means of performing authentication and/or encryption and/or decryption, such as but not limited to dynamic authentication methods such as dynamic pairing as described in the commonly-owned patent application entitled The Unpassword: Risk Aware End-to-End Multi-Factor Authentication via Dynamic Pairing, filed on Mar. 17, 2014 and assigned application Ser. No. 14/217,202, now issued U.S. Pat. No. 9,407,619 (Attorney Docket 12188-014).

Multiple methods of authentication and/or encryption and/or decryption could also be supported such as but not limited to the methods described in the commonly-owned patent application entitled Multi-Instance Shared Authentication (MISA) Method and System Prior to Data Access, filed on Jun. 23, 2016 and assigned application Ser. No. 15/191,456 (Attorney Docket 12188-018).

Cryptographic features within the electronics on or in the accessory could also serve as a secure boot as well as support secure updates. Under these methods, the crypto chip could validate signatures on one or all parts of code or binary to prevent duplication (such as frequently used by malware programs). Likewise, the crypto within the electronics could be used to authenticate other peripheral devices and/or updates and/or boot loads for those devices. Lastly, crypto features within electronics within peripherals and other accessories might need to authenticate with crypto within electronics with one or more other accessories before access to private information and/or transactions may be directed by a user. Last, users may be authenticated by biometric keys stored within the crypto key manager, or by models that whose signature is authenticated by the crypto key manager.

Electronics may also include LEDs to serve for such purposes as on/off indication, all contents present or one or more contents missing, one or more peripherals are missing, authorization validation, low battery, and the like. Likewise, this and other information could be notified to a user by showing it on a display, vibration over vibration device and/or sounds or voice over a speaker.

Electronics could also possess low power features such as a state-machine, where the processor is clocked at a different rate for a given action. Likewise, various sensors and buttons could be used to keep the processor off, or in a near off sleep-state, to reduce power consumption for mundane tasks that do not require processing power.

Under certain embodiments of this invention, users may automatically or manually categorize financial transactions as they perform them. In some embodiments, the financial transactions may be automatically sent to an accounting system, where all expenditures are categorized per their associated category or accounting code in order to facilitate accounting processes. Once transactions have been categorized and recorded, one or more user devices or applications of those devices may then be utilized to produce financial statements or summaries. Financial statements or summaries may then be communicated to one or more user devices in near real-time. Such an invention in all its aspects, permutations and embodiments described herein achieve a “pocket accountant” system.

The teachings of the present invention can also be used in conjunction with crypto currencies, such as described in commonly-owned patent application entitled Electronic Crypto-Currency Management Method and System, filed on Aug. 1, 2016 and assigned application Ser. No. 15/225,780 (Attorney Docket 12188-023), and also in conjunction with accessory-to-accessory payment transactions such as described in commonly-owned patent application entitled Low Bandwidth Crypto-Currency Transaction Execution and Synchronization Method and System, filed on Sep. 7, 2016 and assigned application Ser. No. 15/259,023 (Attorney Docket 12188-026).

In summary, the present invention consists of systems and methods to manually or autonomously identify and categorize a transaction or a portion of a transaction. Under this invention, users may automatically or manually select a payment account, card, payment type, transaction device and/or categorize financial transactions as they perform them either local on a mobile or wearable device, or remotely via web, server, robotic or drone device. In some embodiments, the financial transactions may be automatically sent to an accounting system, where all expenditures are categorized per their associated category or accounting code in order to facilitate accounting processes.

A portion of a transaction could be an item purchased along with its given price, store name and/or location. Categorization and identification may be executed using specific financial information from a transaction referenced herein as identifiers. Identifiers and/or codes representing identifiers may be sent by a sending entity to a user device and/or application. In one method, categorization may be determined directly from the identifiers either by a sending entity or a user device and/or application. However, in another method the category may be predetermined by the sending entity and sent to the user device and/or application in a code referenced herein as an indicator.

Various accounting, transactional and financial statements, summaries and other information, collectively called “transactional information”, may then be communicated to one or more user devices. Transactional information may include but are not limited to budget reports, income statements, balance sheets, over drafts and/or statement of cash flows. This transactional information may be configured by a user or group of users, and displayed on one or more user devices. Such an invention in all its aspects, permutations and embodiments described herein achieve a “pocket accountant” system.

According to another embodiment of the invention, a user can authenticate to a first device using known authenticate techniques such as voice, facial recognition, behavior metrics, biometrics, gesture, etc. Once authenticated to the first device (a smart phone for example) the first device advises one or more second devices (pragmatically, there will be a plurality of such second devices) of the user's successful authentication to the first device. Each of the second devices would have otherwise required independent user authentication. But according to this embodiment of the present invention, authentication of the user to the first device and alerting the second devices to that successful authentication avoids user authentication to the second devices.

Notification of the successful authentication can be communicated from the first device to the second devices by any communication scheme (e.g., Bluetooth, BLE, RF, WiFi, NFC), by inductive communications, or by direct conductive communication (i.e., physically mating) between the first device and the second devices.

However, a system employing these features must ensure, over time, that the second device(s) remain in possession and control of the user who had previously been authenticated to the first device. This second authentication (which can be considered a “liveness” test) would typically be less intrusive, or even passive, relative to the initial authentication to the first device. For example, assuming that the second device comprises a wristwatch, the second device can sense the wearer's actual heart beat or heart rhythm and compare to a stored heart beat or rhythm of the authenticated user. A match confirms that the present wearer of the wrist watch is indeed the same individual who had earlier been authenticated to the first device at an earlier time when a more rigorous authentication procedure had been employed. But the second authentication executed by the wrist watch is clearly less intrusive to the user than the first authentication. As long as the user continues to satisfy the tests associated with the second authentication, he/she can perform any operation or conduct any transactions using the second device. Other passive or less intrusive authentication techniques employed by a second device may comprise: scent sensing, entry of a behavior metric, DNA sensing, iris sensing, or another passive and/or less intrusive authentication process than the authentication process employed with the first device

Another example relates to a smart phone and a user's glasses. The user is first authenticated to the smart phone, which then advises the glasses of the successful authentication. The glasses can then be used to perform an action, unlock a secure device, conduct a transaction, etc. as if the user had been initially and directly authenticated to the glasses.

Clearly this system is advantageous in the world of today where every user has a multitude of passwords, at least one for each secure system or device, that she/he cannot remember and cannot remember to which system or device each applies.

In an embodiment where the plethora of second devices are used to carry out a transaction (or carry out different transactions or different segments of a single transaction), each might be associated with different parameters for executing a transaction. Each of the second devices may be associated with a different credit account, for example. Once each of the second devices has been advised of the user's authentication, the user can select that second device associated with the credit account that he/she wishes to use for the purchase. Or each one of the second devices can be associated with a different currency. Again, the user selects the second device associated with the desired currency for making a payment or making a purchase.

Another aspect of this embodiment relates to the time interval that the first authentication remains valid. After the expiration of this time interval the user must again authenticate to the first device and once successfully re-authenticated the first device advises its associated second devices of the successful re-authentication.

Generally, each of the second devices will have the same authentication validity period. However, this is not required as certain ones of the second devices may require more frequent authentication than others of the second devices. Those requiring more frequent authentication may be associated with a device or locale or transaction having higher or more stringent security requirements. For example, a twelve-hour validity period may apply to use of a credit card, whereas access to a secure facility may impose only a four-hour validity period. Prior to permitting access to a bank account using one of the second devices, for example, the bank's authentication engine may check to determine the length of time since the user's last successful authentication to the first device. If this interval is deemed excessive, the authentication may require re-authentication to the first device or may require the user to submit additional authentication metrics to the second device before access to the bank account is permitted.

In another embodiment, since the first device can communicate with each of the second devices, as it must to relay the successful authentication to each second device, the first device can also share other information with selected one or more of the second devices. This information may be resident on the first device or may be stored on one of the second devices and communicated therefrom to the first device for subsequent communication to other ones of the second devices.

According to another embodiment, once authenticated to the first device the user can request execution of a transaction, a financial transaction for example. The first device advises each of the second devices of the user's successful authentication and executes the financial transaction or commands/controls one of the second devices to execute the transaction. Recording the particulars of the transaction can be performed by the first device, by the second device that executed the transaction or by a different one of the second devices. Selection of the device to record the transaction can be made by the user at the time the transaction is executed or automatically according to the particulars of the transaction (e.g., transaction value, site of execution, other transaction particulars). For example, the user can be authenticated to his smart phone (the first device) and request that a card (one of the second devices) execute the transaction, but only after the smart phone has advised the card of the user's successful authentication.

According to yet another embodiment, one of the second devices stores reward points based on the user's loyalty status with a retailer. Another one of the second devices stores currency. When the user enters the retailer's establishment (and following successful authentication to the first device and relaying of that successful authentication to both of the pertinent second devices) the user can select either one of these second devices to make a purchase from the retailer. Alternatively, the first device can select from between the two second devices depending on the cost of the user's purchase, the balance in the user's reward fund, and the currency balance.

What is claimed is:

1. A system for managing a transaction, the system comprising:
a content-storing component for use in conducting the transaction;
a transaction-detecting component for determining when the content storing component is performing the transaction; and
a recording component for recording the transaction.

2. The system of claim 1 wherein the transaction relates to information, which comprises personal information, financial information, reward information, or loyalty information.

3. The system of claim 1 for assigning a code to the transaction, the code for use in categorizing the transaction.

4. The system of claim 1 wherein the transaction-detecting component further determines whether the content-storing component has performed a transaction during a past time interval of predetermined length.

5. The system of claim 1 wherein the transaction is conducted at a transaction-conducting device, wherein the recording component receives transaction details from the transaction-conducting device for recording the transaction.

6. The system of claim 5 wherein the recording component receives the transaction details from the transaction-conducting device over a wireless link or via a magnetic field.

7. The system of claim 1 wherein the transaction-conducting device comprises a point-of-sale terminal.

8. The system of claim 1 wherein the transaction is conducted at a transaction-conducting device interfacing with a transaction-controlling device, wherein the recording component receives transaction details from the transaction-controlling device for recording the transaction.

9. The system of claim 1 further comprising a personal storage accessory for storing the content-storing component and a proximity-detecting component for detecting whether the content-storing component is within or proximate the personal storage accessory.

10. The system of claim 9 wherein the personal storage accessory notifies a user as to removal of the content-storing component from the personal storage accessory or presence of the content-storing component within the personal storage accessory.

11. The system of claim 9 wherein the proximity-detecting component comprises a switch, a radio frequency device, an optical proximity sensor, a reed-type switch or a Hall effect switch.

12. The system of claim 1 wherein user authentication is required prior to use of the content-storing component.

13. The system of claim 1 further comprising a personal storage accessory for storing the content-storing component, one or more of the recording component, the content-storing component or the personal storage accessory for recording the transaction.

14. The system of claim 13 wherein the personal storage accessory comprises an electronics device, and upon the system detecting that the content-storing component is not within or proximate the personal storage accessory, either or both of the electronics device and the content-storing component are activated.

15. The system of claim 13 wherein the personal storage accessory comprises any one of a smart wallet, a phone, a watch, a wristlet, luggage, a tablet computer, a laptop computer, an IoT (Internet of Things) device, a mobile electronics device, a portable electronics device, and a wearable device.

16. The system of claim 1 further comprising a personal storage accessory and wherein the transaction comprises a financial transaction, the personal storage accessory for categorizing or recording financial information related to the financial transaction.

17. The system of claim 14 wherein the financial information comprises any one or more of, a user name, a transaction category, an amount spent, a budget, an accounting code representing the transaction, and a party with whom the financial transaction was executed.

18. The system of claim 1 further comprising a personal storage accessory, wherein the content-storing component can perform only a single transaction, and wherein the system detecting removal of the content-storing component from the personal storage accessory prepares the content-storing component to execute the single transaction.

19. The system of claim 1 wherein the content-storing component comprises a transaction card.

20. The system of claim 1 wherein the content-storing component receives a transmitted signal from a transmitting device and transmits a reply signal or performs an action responsive to the transmitted signal.

21. The system of claim 1 wherein the user must be authenticated prior to conducting the transaction, and wherein one or both of the authentication information and information related to the transaction are separated into segments and each segment is processed separately within the system.

22. The system of claim 21 wherein the authentication information comprises multi-factor authentication information.

23. The system of claim 1 further comprising a personal storage accessory and a controlling device for communicating with one or both of the personal storage accessory and the content-storing component for controlling or identifying a transaction to be conducted.

24. The system of claim 23 wherein the controlling device comprises a user interface, controlling information supplied to the user interface comprises one or more of a biometric, a behavioral metric, a knowledge metric and an electronics metric, and the system further comprises a user interface for a user to supply instructions related to the transaction to the controlling device.

25. The system of claim 1 further comprising a personal storage accessory, and wherein the content-storing component comprises a communications component for communicating with one or both of the personal storage accessory and a device associated with conducting the transaction.

26. The system of claim 25 wherein the communications component is associated with a predetermined transaction.

27. The system of claim 25 wherein the communications component comprises first physical contacts for contacting second physical contacts disposed on the personal storage accessory to allow the content-storing component and the personal storage accessory to exchange information.

28. The system of claim 25 wherein the communications component sends and receives information using electromagnetic or magnetic fields.

29. A system for managing loyalty rewards earned by a consumer, the system comprising:
a first component for use in conducting a transaction subject to a loyalty reward;
a second component for determining that the first component has performed a transaction; and
a third component for recording a reward based on the transaction.

30. The system of claim 29 wherein the first, second and third components are disposed on a card.

31. The system of claim 29 wherein the loyalty reward is stored on the first component.

32. The system of claim 29 wherein a loyalty reward amount is responsive to one or more of a value of the transaction, a monetary value of the transaction, and a product or service associated with the transaction.

33. A system for conducting a transaction comprising:
a user authenticating to a first device;
the first device communicating to one or more second devices that the user has been successfully authenticated to the first device; and
the one or more second devices for conducting the transaction under control of the user.

34. The system of claim 33 wherein the system records the transaction.

35. The system of claim 33 wherein each one of the second devices is associated with a predetermined transaction for executing the predetermined transaction or is associated with predetermined transaction parameters related to a transaction.

36. The system of claim 35 wherein the user selects from among the second devices for executing a predetermined transaction or for executing a transaction according to predetermined transaction parameters.

37. The system of claim 33 wherein the first device communicates to the one or more second devices using a Bluetooth, BLE, RF, WiFi, or NFC communications technique.

38. The system of claim 33 wherein at least one of the second devices re-authenticates the user after a predetermined time from user authentication by the first device.

39. The system of claim 38 wherein the predetermined time is different among the second devices.

40. The system of claim 38 wherein a re-authentication comprises scent sensing, entry of a behavior metric, DNA sensing, iris sensing, heart beat sensing, or heart rhythm sensing.

41. The system of claim 33 the user authentication to the first device remaining valid for a predetermined time after the expiration at which time the user must again authenticate to the first device.
